(19) United States
(12) Patent Application Publication
(10) Pub. No.: US 2021/0347587 A1
(43) Pub. Date: Nov. 11, 2021

(54) PACKAGE LOADING AND DISTRIBUTION SYSTEM

(71) Applicant: Avraham Y. Levi, Eagan, MN (US)

(72) Inventor: Avraham Y. Levi, Eagan, MN (US)

(21) Appl. No.: 16/868,159

(22) Filed: May 6, 2020

(51) Int. Cl. B65G 67/08; B65G 67/20; B65G 21/12

(52) U.S. Cl. CPC B65G 67/08; B65G 2201/025; B65G 21/12; B65G 67/20

(57) ABSTRACT

In the method of the present invention, first and second motorized endless belt conveyor assemblies are provided, one for placement in a package distribution center and the other for placement in the box of a delivery truck or van. Personnel at the distribution center load the conveyor of the first conveyor assembly with packages in a predetermined order corresponding to stops on a route. Subsequently, a delivery driver will back his vehicle up to the first conveyor assembly and activate the motorized conveyors of the two conveyor assemblies such that products on the first conveyor assembly will be transferred onto the conveyor assembly located in the vehicle in the stated predetermined order.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

### I. Field of the Invention

The present invention relates generally to methods and systems for delivering packages and, more particularly, to a method of organizing packages for delivery along a preplanned route at a distribution center and for loading the packages in the organized manner into a delivery van whereby efficiency of delivery is improved.

### II. Discussion of the Prior Art

In implementing customer home and shop delivery systems, it is common practice for packages to be first sent by a retailer to a product distribution center where packages are sorted and loaded onto delivery vehicles for delivery to the ultimate customer. The Hardy et al U.S. Pat. No. 4,832,204 describes a package handling and sorting system that aggregates packages according to destination so that those headed for the same destination will be combined for loading on a delivery vehicle whose route includes that destination. This is accomplished utilizing a computing system having a label scanning input device for performing a sorting operation.

The Baldassari et al U.S. Pat. No. 7,118,034 also describes a package sorting system where the packages include a radio-frequency identification tag for facilitating pre-loading the package in a vehicle for delivery to the package's final destination.

The present invention differs from the above-prior art in that it provides a streamlined way of loading packages for delivery into a delivery van or truck after the sorting process has been carried out at a distribution center location.

### SUMMARY OF THE INVENTION

The present invention provides a method for loading a delivery vehicle, such as a van or truck, in which first and second conveyor assemblies are provided where each comprises a plurality of sets of motor-driven endless belt conveyors. The conveyors are held in vertically spaced-apart, horizontally extending relation, much like shelving, and where the individual sets of the conveyor assemblies are positioned next to one another in side-by-side relation.

The first conveyor assembly is installed in the delivery vehicle and the second conveyor assembly remains in the package distribution center. Packages to be delivered are first loaded by distribution center personnel onto the endless belt conveyors of the conveyor assembly that remains in the distribution center in a predetermined order which may be dictated by a prior art package sorting system. Before embarking on a delivery route, a driver will back the delivery vehicle such that its rear loading door is positioned downstream of the now loaded conveyor assembly. Now, the motor driven endless belt conveyors of the first and second conveyor assemblies can be driven to transfer the pre-sorted packages on the distribution center conveyor assembly onto the endless belt conveyors of the first conveyor assembly installed in the delivery vehicle.

This mechanized vehicle loading method eliminates delay otherwise required if the vehicle has to be loaded manually with the packages properly in order for sequential delivery along a predetermined route by the driver. The reader will appreciate that the conveyor assembly that remains in the distribution center can be loaded with packages in a desired order well in advance of the time for deliveries to begin. The invention also allows better utilization of the vehicle cargo volume, as not like shelving, the driver does not need to enter the cargo area between shelves.

### BRIEF DESCRIPTION OF THE DRAWINGS

The foregoing features, objects and advantages of the invention will become apparent to those skilled in the art from the following detailed description of the preferred embodiment, especially when considered in conjunction with the accompanying drawings in which like numerals in the several views refer to corresponding parts:

FIG. 1 illustrates a first conveyor assembly that has been pre-loaded with packages at a distribution center that have been pre-sorted to accommodate stops along a given delivery route positioned directly adjacent a delivery door of a transport vehicle;

FIG. 2 is similar to FIG. 1, but the vehicle is shown as being transparent to reveal a separate conveyor assembly installed in the delivery vehicle;

FIG. 3 is a view like FIG. 2 during a transfer of pre-sorted packages from the conveyor assembly of the distribution center to the conveyor assembly installed on the delivery vehicle;

FIG. 4 shows the packages fully transferred; and

FIG. 5 is an exploded view of an endless belt conveyor comprising the two conveyor assemblies.

### DESCRIPTION OF THE PREFERRED EMBODIMENT

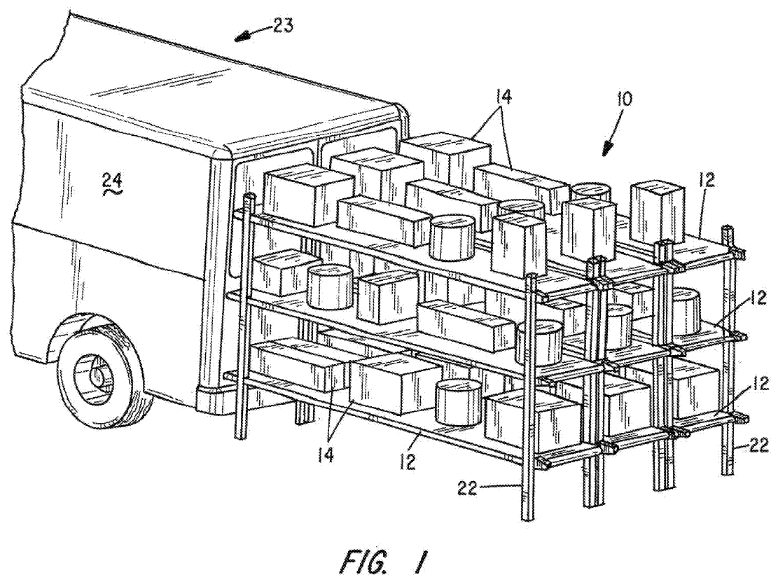

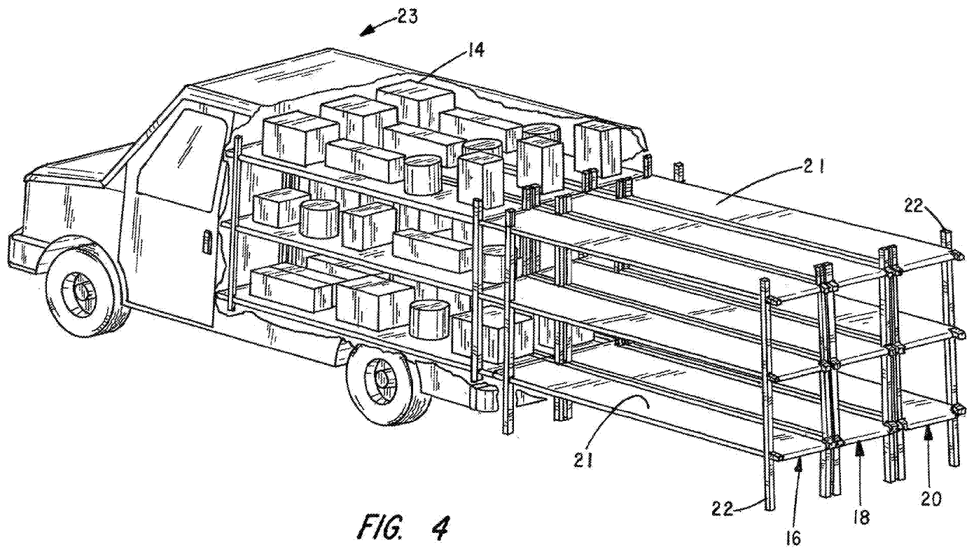

In each of FIGS. 1-4, there is shown a first endless belt conveyor assembly, indicated generally by numeral 10, that would be typically located in a package distribution center and, upon the movable shelves 12 thereof, are loaded a plurality of packages 14 to be delivered to customers. The packages are pre-sorted either by an automated system or by distribution center personnel and placed on the shelves (conveyors) in a desired order for delivery at stops along a predetermined route.

The conveyor assembly 10 is comprised of a plurality of sets 16, 18, 20 of motorized endless belt conveyors 21 where the conveyor members of each set are held in vertically spaced-apart, horizontally extending relation by appropriately located vertically extending leg members 22 that are fastened to conveyor side rails.

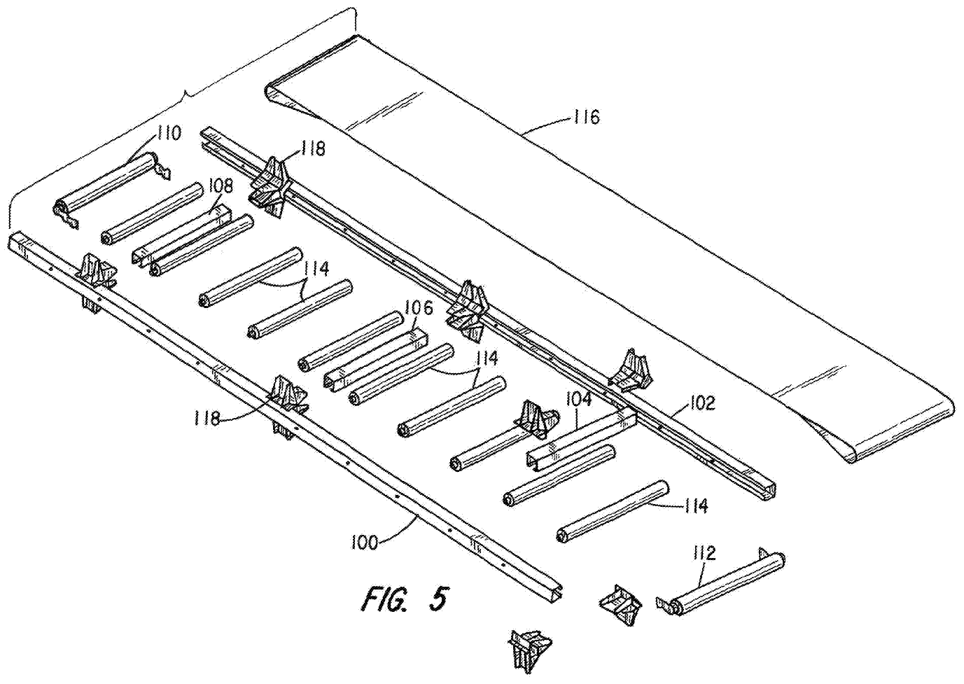

FIG. 5 is an exploded view of a typical one of the endless belt conveyors comprising the assemblies shown in FIGS. 1-4. It is seen to comprise two elongated tubular side rails 100 and 102 that are held in parallel, spaced-apart relation by cross struts 104, 106 and 108 that clamp to the side rails. Journaled for rotation between the side rails 100 and 102 are a motor-driven end roller 110, an endmost idler roller 112 and a plurality of regularly space-apart intermediate rollers, as at 114, that provide support for a flexible endless belt 116 that spans the motorized roller 110 and the opposite end roller 112.

The motor driven end roller 110 includes a pair of stationary shafts on which ball bearing sets are mounted so that their outer race is free to rotate. The motor also has a stationary shaft and its rotor is operatively coupled to the outer races of the bearings so as to spin an outer tuber roller that interfaces with the endless belt.

Frame connector brackets, as at 118, connect to the side rails 100, 102 to not only serve as belt guides that restrict lateral shifting thereof, but also to allow the side rails of multiple conveyors to be connected to the legs 22 of the conveyor sets 16, 18, 20, allowing the individual endless belt conveyors to be stacked one above the other, as shown in FIGS. 1-4.

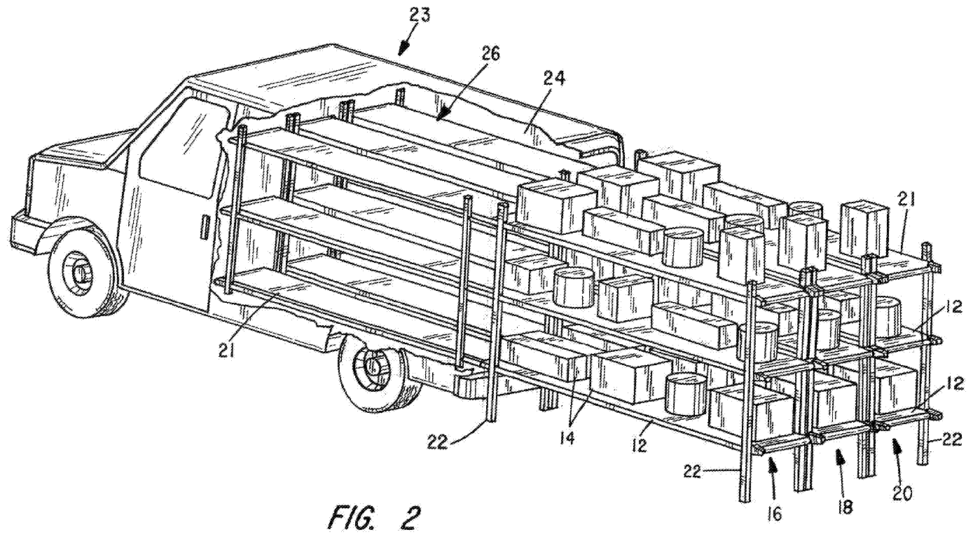

As seen in FIG. 2, the delivery vehicle 23 is shown as being transparent. Contained in its load compartment 24 is a motorized endless belt conveyor assembly indicated generally by numeral 26 that is also partitioned into a plurality (three) sets where the shelf-like conveyors in each set when installed in the vehicle are at the same elevation and spacing as the ones comprising the exterior conveyor assembly 10.

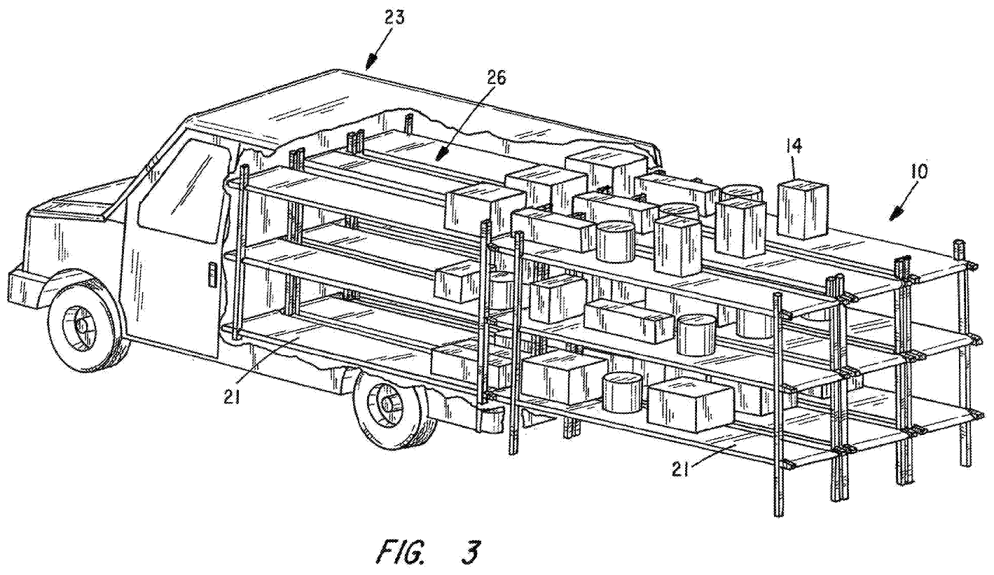

FIG. 3 shows the delivery van 23 backed up to the conveyor assembly 10 and with the motorized endless belt conveyors in the dual conveyor assemblies 10 and 26 in operation. The packages that had previously been sorted and arranged on the conveyors of the assembly 10 are shown as being transferred onto the conveyor assembly 26 that is installed in the vehicle 23. Once the transfer is completed, the vehicle is ready to embark on its route. The delivery stops will have previously been programmed into the vehicle's GPS tracking system. Upon arrival at a stop, a particular one of the plural endless belt conveyors is energized to bring one or more packages destined for that stop to the delivery person now located at the vehicle's delivery door.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A method of loading a delivery van at a package distribution center comprising the steps of:
(a) providing first and second conveyor assemblies, each of said first and second conveyor assemblies, each comprising at least one set of motor-driven endless belt conveyors, the endless belt conveyors of the at least one set being held in vertically spaced-apart, horizontally extending relation;
(b) installing the first conveyor assembly in a delivery van and installing the second conveyor assembly in the package distribution center;
(c) loading packages to be delivered in a predetermined order onto the motor-driven endless belt conveyors of the at least one set comprising the second conveyor assembly;
(d) later positioning the delivery van with its loading door closely adjacent a discharge end of the endless belt conveyor in the second conveyor assembly; and
(e) turning on the motor-driven endless belt conveyors of the first and second conveyor assemblies to transport the packages to be delivered from the second conveyor assembly onto the endless belt conveyors of the first conveyor assembly.

2. The method of claim 1 wherein the first and second conveyor assemblies each include a plurality of said sets positioned adjacent one another in side-by-side relation.

3. The method of claim 1 wherein each set comprises a plurality of endless belt motor driven conveyors held in horizontal spaced-apart relation by a plurality of vertically extending leg members affixed to conveyor side rails.

4. The method of claim 3 wherein the plurality of endless belt conveyors on the first conveyor assembly are spaced apart vertically by the same spacing as used between the endless belt conveyors on the second conveyor assembly such that when the delivery van is positioned with its loading door closely adjacent the discharge end of the plurality of endless belt conveyors in a second conveyor assembly, the endless belt conveyors on the first and second conveyor assemblies are horizontally aligned.
